(19) United States
(12) Patent Application Publication
(10) Pub. No.: US 2011/0171940 A1
(43) Pub. Date: Jul. 14, 2011

(54) Call Adapter for Cellular Phones

(76) Inventor: Jehuda Julian Dinur, Haifa (IL)

(21) Appl. No.: 12/978,445

(22) Filed: Dec. 24, 2010

Related U.S. Application Data
(60) Provisional application No. 61/293,624, filed on Jan. 9, 2010.

(51) Int. Cl. H04W 4/16; H04W 88/02

(52) U.S. Cl. 455/414.1

(57) ABSTRACT

A system, method, and call adapter for processing cellular phone's placed calls on its wireless enabled link are presented.

For placing a call from a cellular phone on its wireless enabled link (such as Bluetooth, Wi-Fi) the calling party transmits data, from the cellular phone, associated with the called party to a call adapter through the wireless communication link. The transmitted data can contain necessary data for placing the call (such as telephone number, alias, e-mail address, web address) as well as unnecessary data (such as postal address). The call adapter receives wireless transmitted data, extracts the required data for placing the call, and establishes the call on the PSTN (public switched telephone network) or on a broadband network (such as cable, satellite, DSL-digital subscriber line), according to the calling party selection. The call adapter forwards the call to a telephone with handset (corded or cordless), to a cellular phone, to another device on the same wireless network as the cellular phone, or to a device on a different wireless network, according to the calling party's selection. The call adapter releases the call after the communication is over (for example after the telephone handset is on-hook).

The call adapter may be implemented as a standalone device and may be implemented as part of other devices (such as in telephone sets, broadband modems, set-up-boxes, and PC).

### REFERENCE TO CROSS-RELATED APPLICATION

This application claims priority from U.S. Provisional Application No. 61/293,624, filed on Jan. 9, 2010, herein incorporated by reference in its entirety.

### FIELD OF THE INVENTION

The present invention relates to a new and improved system and method, for processing cellular phone's placed calls on its wireless enabled link, more particularly to a method and a new and improved system, including a call adapter, for processing cellular phone's placed calls on its wireless enabled link.

### BACKGROUND OF THE INVENTION

The cellular phones offer a great deal of out-of-the-office/residency conveniences but the costs of cellular conversations are significantly higher than similar calls using the PSTN (public switched telephone network) or broadband networks and may expose the calling party to undesirable cellular radiation.

The prior arts do not teach or suggest a system, method and call adapter for processing cellular phone's placed calls on its wireless enabled link.

There is therefore a need for a new and improved system, and method for processing cellular phone's placed calls on its wireless enabled link.

### SUMMARY OF THE INVENTION

According to the present invention there is a convenient and cheaper method and a new and improved system, including a call adapter, for processing calls placed from a cellular phone on its wireless enabled link.

The method consists of transmitting the called party's associated data in a defined file format from a cellular phone on its wireless enabled link to a call adapter, establishing the call on PSTN or on a broadband network according to the calling party selection and forwarding the call to a telephone or to a wireless enabled device, according to the calling party selection and releasing the call.

The method according to the present invention allows placing a call from a cellular phone on a wireless enabled link through a call adapter, to establish a call, to forward the call to a landline network device or to a wireless enabled device, according to the calling party selection and to release the call after the end of the communication.

Wireless enabled devices are devices connected by wireless (communication) links (other than cellular, such as Bluetooth, Wi-Fi). Wired network devices are landline devices connected by wired communication links (such as telephones on PSTN).

For illustrative purposes, consider an example of a system including a Bluetooth-enabled standalone call adapter connected to a regular/traditional telephone, to the PSTN, to a Bluetooth-enabled cellular phone and to a Bluetooth-enabled headset.

In order to place a call from the Bluetooth-enabled cellular phone through the call adapter, the calling party may select the called party from a list of names stored in the cellular phone and transmit the associated data in a defined file format (such as vCard for electronic “business cards”) to the call adapter through the Bluetooth link. The call adapter may receive the data and extract the called party phone number, dial the phone number, play the dial tones and the ring tones and establish the call. The call adapter may forward the dial tones and the ring tones and the call to the telephone's handset or through the Bluetooth link to the cellular phone or to the Bluetooth-enabled headset, according to the calling party selection.

The call adapter may detect the communication end and release the call.

The call adapter may be implemented as a standalone device and may be implemented as a part of other devices (such as telephone sets, broadband modems, set-top-boxes, and personal computer (PC)).

According to the teaching of the present invention there is provided a communication system including (a) a CA (call adapter), the call adapter including a CA interconnection bridge and microprocessor.

According to a further teaching of the present invention the call adapter further includes a CA telephone interface operatively connected to the CA interconnection bridge and microprocessor.

According to a still further teaching of the present invention the call adapter further includes a CA broadband interface operatively connected to the CA interconnection bridge and microprocessor.

According to another further teaching of the present invention the call adapter further includes a CA PSTN interface operatively connected to the CA interconnection bridge and microprocessor.

According to still another further teaching of the present invention the call adapter further includes at least one CA wireless module operatively connected to the CA interconnection bridge and microprocessor.

According to still another further teaching of the present invention the call adapter further includes: a CA display operatively connected to the CA interconnection bridge and microprocessor; at least one CA user interface operatively connected to the CA interconnection bridge and microprocessor; at least one CA LEDs operatively connected to the CA interconnection bridge and microprocessor; and a CA speaker operatively connected to the CA PSTN interface.

According to still another further teaching of the present invention the communication further includes: a cellular phone (wireless enabled) operatively connected to the call adapter; and a telephone operatively connected to the call adapter.

According to still another further teaching of the present invention the communication system further includes: at least one call forwarded wireless enabled device operatively connected to the call adapter.

According to still another further teaching of the present invention the communication system further includes: a cellular phone (wireless enabled) operatively connected to the call adapter; and a telephone operatively connected to the call adapter.

According to still another further teaching of the present invention the communication system further includes at least one call forwarded wireless enabled device operatively connected to the call adapter.

According to a still further teaching of the present invention the call adapter is a STB (set-top-box) call adapter, and the CA interconnection bridge and microprocessor is a STB interconnection bridge and microprocessor.

According to a still further teaching of the present invention the STB call adapter further includes: at least one interface selected from a group consisting of a STB broadband interface, a STB PSTN interface, a STB wireless module, and a STB user interface.

According to the teachings of the present invention there is provided a method of placing, establishing, forwarding and releasing a call, comprising the main stages of: starting the call adapter configuration and placing, establishing, forwarding and releasing a call; placing the call; establishing the call; forwarding the call; releasing the call; and ending the call adapter configuration and placing, establishing, forwarding and releasing the call.

According to another further teaching of the present invention the main stage of starting the call adapter configuration and placing, establishing, forwarding and releasing a call includes the sub-stage of: transmitting the configuration data from a cellular phone (wireless enabled) to the call adapter.

According to still another further teaching of the present invention the main stage of placing the call includes the sub-stages of: inserting called party data on a cellular phone (wireless enabled); and transmitting the called party data from the cellular phone (wireless enabled) to a call adapter.

According to still another further teaching of the present invention the main stage of placing the call includes the sub-stages of: selecting an existent called party on a cellular phone (wireless enabled); and transmitting the called party data from the cellular phone (wireless enabled) to a call adapter.

According to still another further teaching of the present invention the main stage of establishing the call includes the sub-stages of: receiving called party data by a call adapter; extracting the required called party data for call placement by a call adapter and starting a standard establishing call procedure, according to the calling party selection; and playing call progress tones by the call adapter and forwarding call progress tones.

According to still another further teaching of the present invention the main stage of forwarding the call includes the sub-stages of: forwarding a call by a call adapter to a telephone handset.

According to still another further teaching of the present invention the main stage of forwarding the call includes the sub-stages of: forwarding a call to a calling party cellular phone.

According to still another further teaching of the present invention the main stage of forwarding the call includes the sub-stages of: forwarding a call to a call forwarded wireless enabled device.

According to still another further teaching of the present invention the main stage of releasing the call includes the sub-stages of releasing the call by a call adapter after a telephone handset is on-hook.

According to still another further of the present invention the main stage of releasing the call includes the sub-stages of releasing the call by a call adapter after a wireless enabled device's call is released.

Additional objects and advantages of the invention will be set forth in part in the description which follows and, in part, will be obvious from the description, or may be learned by practice of the invention.

### BRIEF DESCRIPTION OF THE DRAWINGS

The invention is herein described, by way of example only, with reference to the accompanying drawings, wherein:

FIG. 1 is a general schematic block diagram of an embodiment of a communication system with standalone call adapter according to the present invention.

FIG. 2 is a schematic block diagram of an embodiment of the all adapter, according to the present invention.

FIGS. 3a, 3b, and 3c, are a flowchart of a method for call adapter configuration and for placing, establishing, forwarding and releasing a call, according to the present invention.

FIG. 4 is a general schematic block diagram of an embodiment of an example communication system with call adapter implemented in a typical set-top-box according to the present invention.

### DETAILED DESCRIPTION OF THE EMBODIMENTS

The present invention is of a method and a system, including, a call adapter, for processing cellular phone's placed calls on its wireless enabled link.

The principles and operation of the, method and the system which includes a call adapter, for processing calls placed on a cellular phone's wireless enabled link, according to the present invention, may be better understood with reference to the drawings and the accompanying description.

Before explaining at least one embodiment of the invention in detail, it is to be understood that the invention is not limited in its application to the details of construction and the arrangement of the components set forth in the following description or illustrated in the drawings.

Unless otherwise defined, all technical and scientific terms used herein have the same meaning as commonly understood by one of ordinary skill in the art to which this invention belongs. The materials, dimensions, methods, and examples provided herein are illustrative only and are not intended to be limiting.

The following list is a legend of the numbering of the application illustrations:

100 communication system with standalone call adapter

101 telephone

102 call adapter

103 first call forwarded wireless enabled device

104 Public Switched Telephone Network (PSTN)

104a public telephone lines PSTN

105 broadband modem

106 broadband network

107 cellular phone (wireless enabled)

108 second call forwarded wireless enabled device

109 first wireless communication link

110 second wireless communication link

201 call adapter (CA) broadband interface

202 CA PSTN interface

203 CA telephone interface

204 CA interconnection bridge and microprocessor

205 CA first wireless module

206 CA second wireless module

207 CA user interface

208 CA display

209 CA Liquid-Emitted Light (LED)s

210 CA speaker

400 example of communication system with call adapter implemented in a typical set-top-box (STB)

401 typical STB with implemented call adapter

402 STB interconnection bridge and microprocessor

403 STB broadband interface

404 STB video interface

405 STB audio interface

406 STB second wireless module

407 STB first wireless module

408 STB display

409 STB user interface

410 STB PSTN interface

411 STB CA

As used herein in the specification and in the claim section that follows, the terms: broadband network; call adapter; communication link; DAA; DSL; LED; set-top-box; VoIP; PSTN; SLIC; Wi-Fi; wireless enabled device and wireless network are as specified in the following list:

The term “broadband network” and the like substantially refer to communications network that provides connectivity across a large area at high speed.

The term “call adapter” and the like substantially refer to a device which may be used to receive a call placing request and establish, forward and release the call.

The term “communication link” and the like substantially refer to the means of connecting one device to another for the purpose of transmitting and receiving information.

The term “DAA” and the like substantially refer to a data access arrangement, circuits that electrically isolate from the phone line, separating from the telephone line higher voltage.

The term “DSL” and the like substantially refer to digital subscriber line, a family of technologies that provides digital data transmission over the wires of a local telephone network.

The term “LED” and the like substantially refer to light-emitting diode, a semiconductor light source used as indicator lamp in many devices.

The term “set-up box” and the like substantially refer to a device that connects to a television and an external source of signal, turning the signal into content which is then displayed on the television screen.

The term “VoIP” and the like substantially refer to voice over internet protocol, a family of transmission technologies for delivery of voice communications over IP networks such as the internet or other packet-switched networks. Other terms frequently encountered and synonymous with VoIP are IP telephony, Internet telephony, voice over broadband (VoBB), broadband telephony, and broadband phone.

The term “PSTN” and the like substantially refer to public switched telephone network, the network of the world's public circuit-switched telephone networks.

The term “SLIC” and the like substantially refer to subscriber line interface circuit, circuit for analog line interface applications, enabling signals to be transmitted and received from the telephone line, feed power to the line and monitor the line condition.

The term “Wi-Fi” and the like substantially refer to Wireless Fidelity, a class of wireless local area network devices.

The term “wireless enabled device” and the like substantially refer to a device with a wireless transceiver other than cellular.

The term “wireless network” and the like substantially refer to any type of network whose interconnections between nodes are implemented without the use of wires.

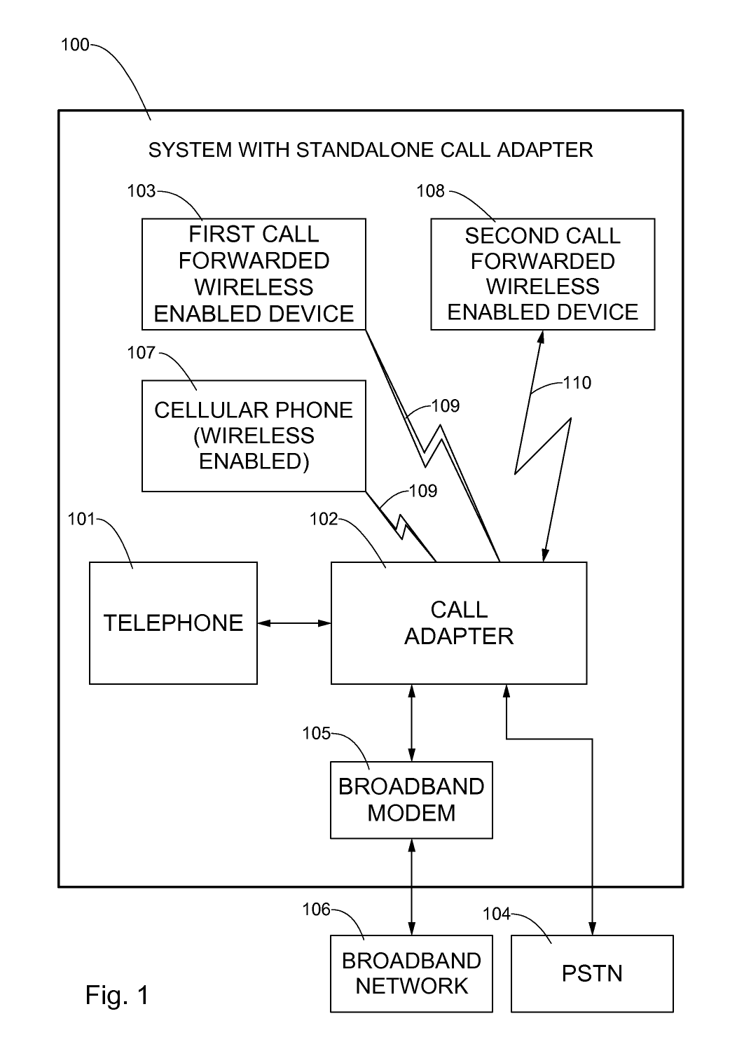

Referring to the drawings, FIG. 1 is a general schematic block diagram of an embodiment of a communication system with standalone call adapter 102, according to the present invention. A call adapter 102 is connected to a PSTN 104 and to a broadband network 106 through a broadband modem 105, and to a cellular phone (wireless enabled) 107, to a first call forwarded wireless enabled device 103 and to a second call forwarded wireless enabled device 108, according to the present invention.

The call adapter 102 is an electronic device that can be connected between a telephone 101 and the PSTN 104 and through the broadband modem 105 to the broadband network 106.

The call adapter 102 transfers all the regularly placed and received telephone calls without any interference.

Through a first wireless communication link 109, (which is usually Bluetooth, however can be any other communication channel, such as Wi-Fi), the call adapter 102 receives, from a cellular phone (wireless enabled) 107 data associated with the required called party. The data may contain data such as the called party name, postal address, phone number, nickname, e-mail and web address. The call adapter 102 extracts from the received data the called party required data to place the call and may start to establish the call to the PSTN 104 or through the broadband modem 105 to the broadband network 106, according to calling party selection. The call adapter 102 can establish the call as a regular/traditional analog call or as a VoIP (voice over internet protocol) call, according to calling party selection. The call adapter 102 can play the dial tones, the ring tones and the busy tones through its speaker (not illustrated here) and can forward the dial tones, the ring tones and the busy tones through the first wireless link 109 to the cellular phone (wireless enabled) 107 or to the first call forwarded wireless enabled device 103, or through a second wireless link 110 to the second call forwarded wireless enabled device 108, according to the calling party selection.

The call adapter 102 can connect the call to the telephone 101 and can forward the call through the first wireless link 109 to the cellular phone (wireless enabled) 107 or to the first call forwarded wireless enabled device 103, or through the second wireless link 110 to the second call forwarded wireless enabled device 108, according to the calling party selection.

The calling party selections may be performed before the call placing by sending from the cellular phone (wireless enabled) 107 a configuration command in a defined format (such as vCard for electronic “business cards”) to call adapter 102, through a first wireless communication link 109. The configuration command may contain data such as PSTN voltage level thresholds, to which device to forward the dialed, ringing and busy tones, and the call, as well as additional data such as if special digits are required to be dialed before each external or long distance phone number. The configuration command may be required only to modify the call adapter 102 configuration and not each time a call is placed.

The components shown in blocks in the present illustration are operatively connected, as described with the arrows.

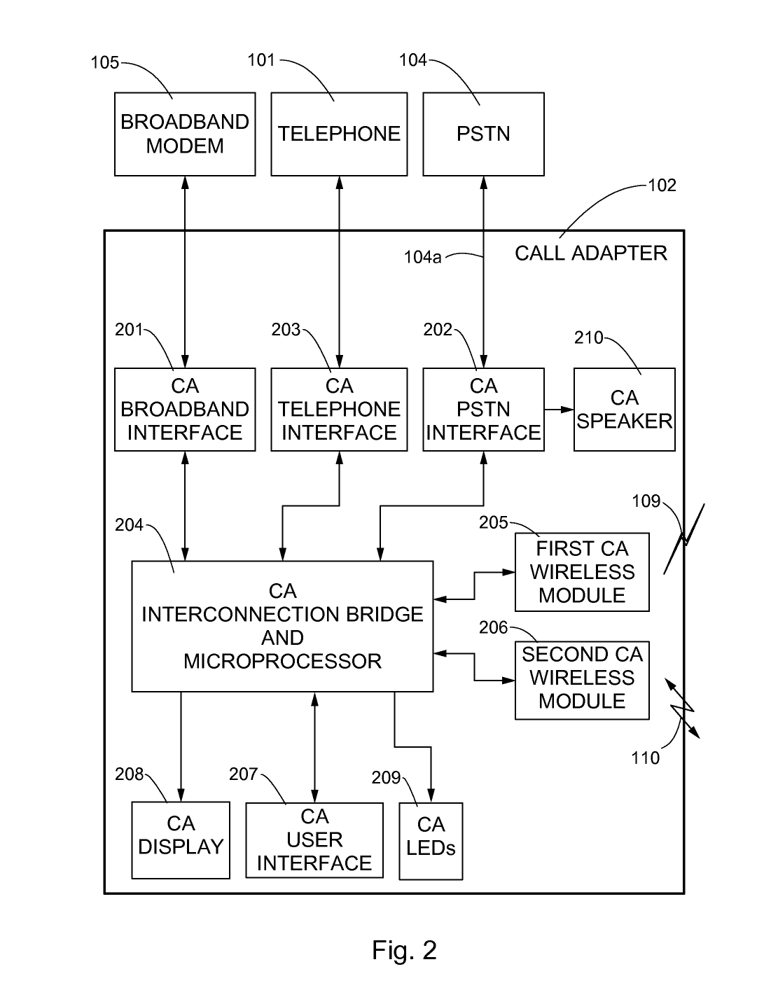

FIG. 2 is a schematic block diagram of an embodiment of call adapter 102, according to the present invention.

A CA interconnection bridge and microprocessor 204 perform the required interconnections between the internal blocks and coordinates the operation of the call adapter 102.

The call adapter 102 may use the CA first wireless module 205 to wirelessly transmit and receive data through the first wireless communication link 109 and may use the CA second wireless module 206 to wirelessly transmit and receive data through the second wireless communication link 110.

A CA broadband interface 201 may be used to provide the standard interface to the broadband modem 105 and is implemented by a standard wired communication interface (such as USB or Ethernet) or a wireless interface (such as Wi-Fi), or any other available communication interface.

The CA PSTN interface 202 is used to provide the standard interface to the public telephone lines PSTN 104a and to the PSTN 104 and is implemented, but not limited to, by a standard DAA (data access arrangement).

A CA speaker 210 is used to play tones such as the dialed tones, ring tones and busy tones.

A CA telephone interface 203 is used to provide the standard interface to the telephone 101 and is implemented, but not limited to, by a standard SLIC (subscriber line interface circuit).

CA user interface 207 is used for setting parameters such as CA speaker 210 volume and performing pairing with devices on the first wireless communication link 109 and with devices on the wireless communication link 110 and is implemented, but not limited to, by standard push buttons.

The call adapter 102 can use a CA display 208 to display information such as call status.

The CA LEDs 209 can be used to display information such as call adapter 102 status.

The components shown in blocks in the present illustration are operatively connected, as shown with the arrows.

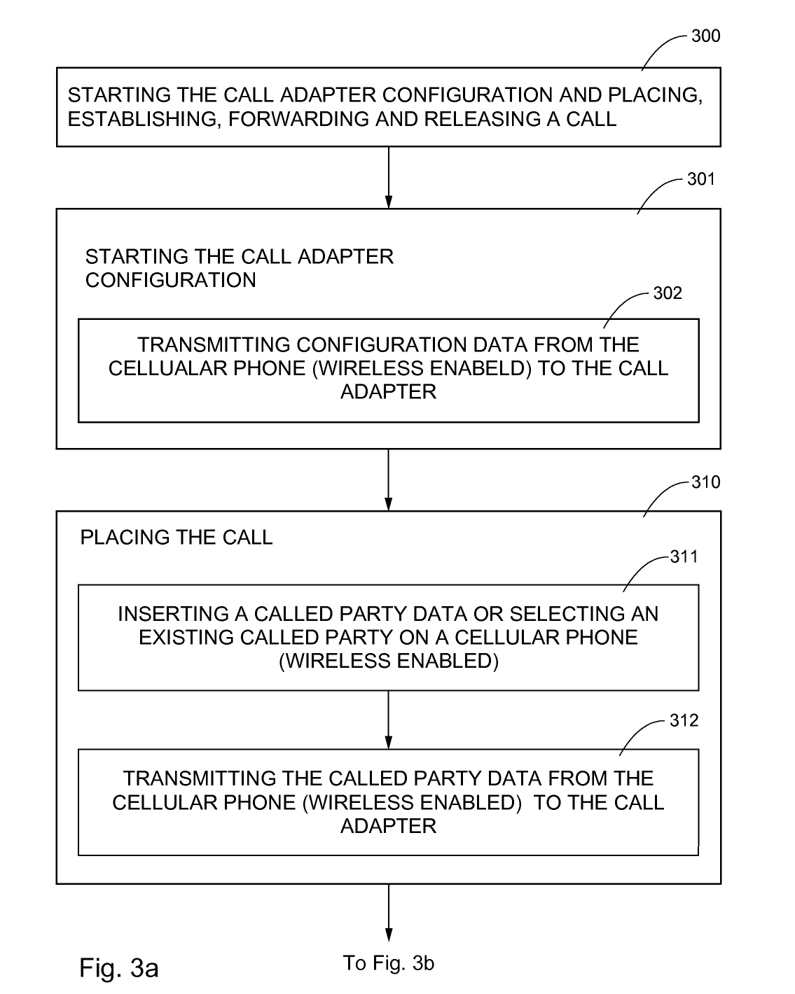

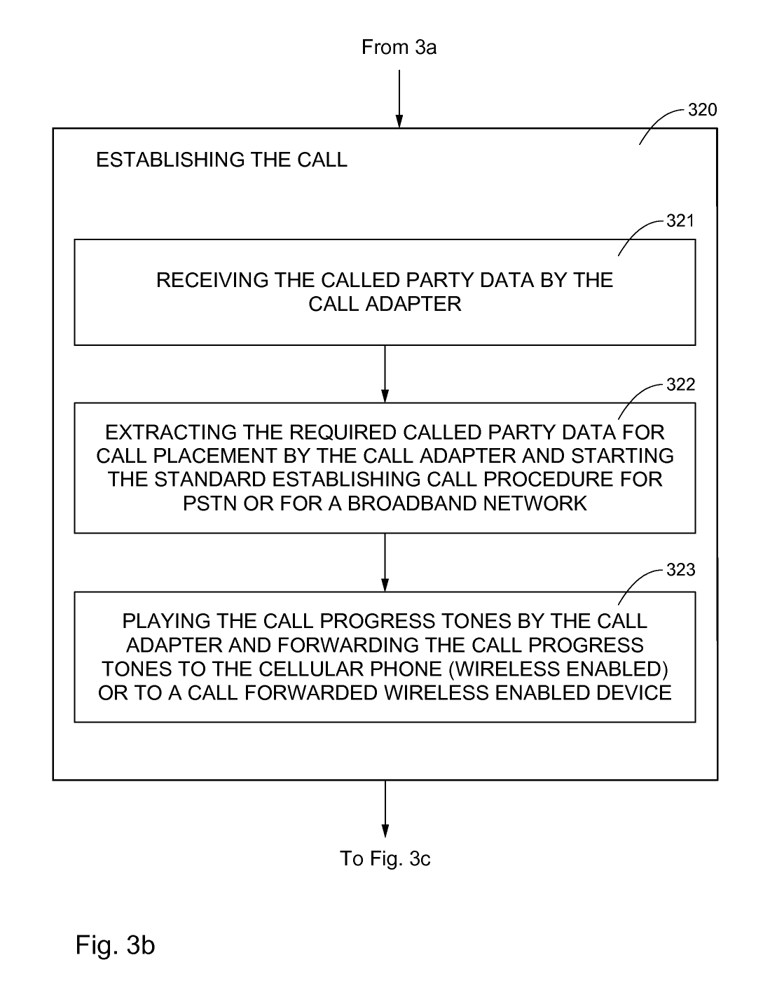

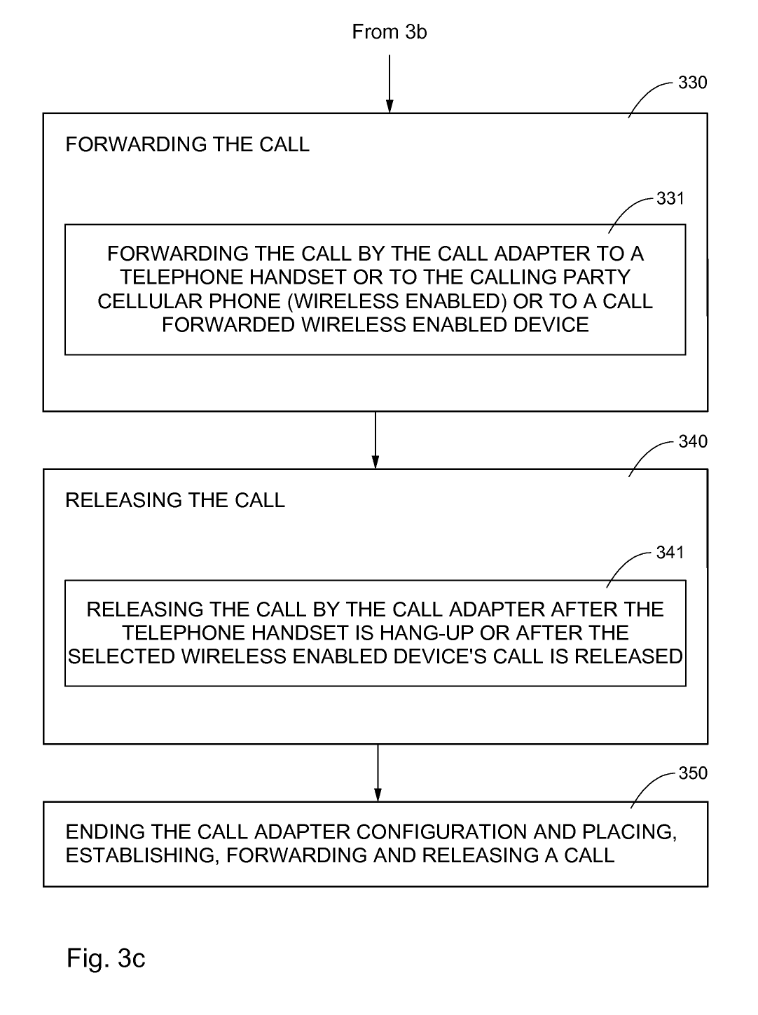

FIGS. 3a, 3b, and 3c, are flowcharts of a method for call adapter configuration and for placing, establishing, forwarding, and releasing a call, according to the present invention.

The method for call adapter configuration and for placing, establishing, forwarding, and releasing a call comprises the main stages of:
starting the call adapter configuration and placing, establishing, forwarding, and releasing a call 300;
starting the call adapter configuration 301;
placing the call 310;
establishing the call 320;
forwarding the call 330;
releasing the call 340; and
ending the call adapter configuration and placing, establishing, forwarding, and releasing a call 350.

The main stage of starting the call adapter configuration 301 comprises the sub-stage of:
transmitting the configuration data from the cellular phone (wireless enabled) to the call adapter 302, (needed only for the modification of the call adapter configuration);

The main stage of placing the call 310 comprises the sub-stages of:
inserting a called party data or selecting an existing called party on a cellular phone (wireless enabled) 311;
transmitting the called party data from the cellular phone (wireless enabled) to the call adapter 312;

The main stage of establishing the call 320 comprises the sub-stages of:
receiving the called party data by the call adapter 321;
extracting the required called party data for call placement by the call adapter and starting standard establishment of a call procedure for PSTN or for a broadband network 322, according to the calling party selection;
playing the call progress tones by the call adapter and forwarding the call progress tones to the cellular phone (wireless enabled) or to a call forwarded wireless enabled device 323;

The main stage of forwarding the call 330 comprises the sub-stage of:
forwarding the call by the call adapter to a telephone handset or to the calling party cellular phone (wireless enabled) or to a call forwarded wireless enabled device 331;

The main stage of releasing the call 340 comprises the sub-stage of:
releasing the call by the call adapter after the telephone handset is on-hook or after the wireless enabled device's call is released 341.

The call adapter can be implemented as a standalone device and can be implemented as a part of other devices (such as telephone sets, broadband modems, set-top-boxes, and PC).

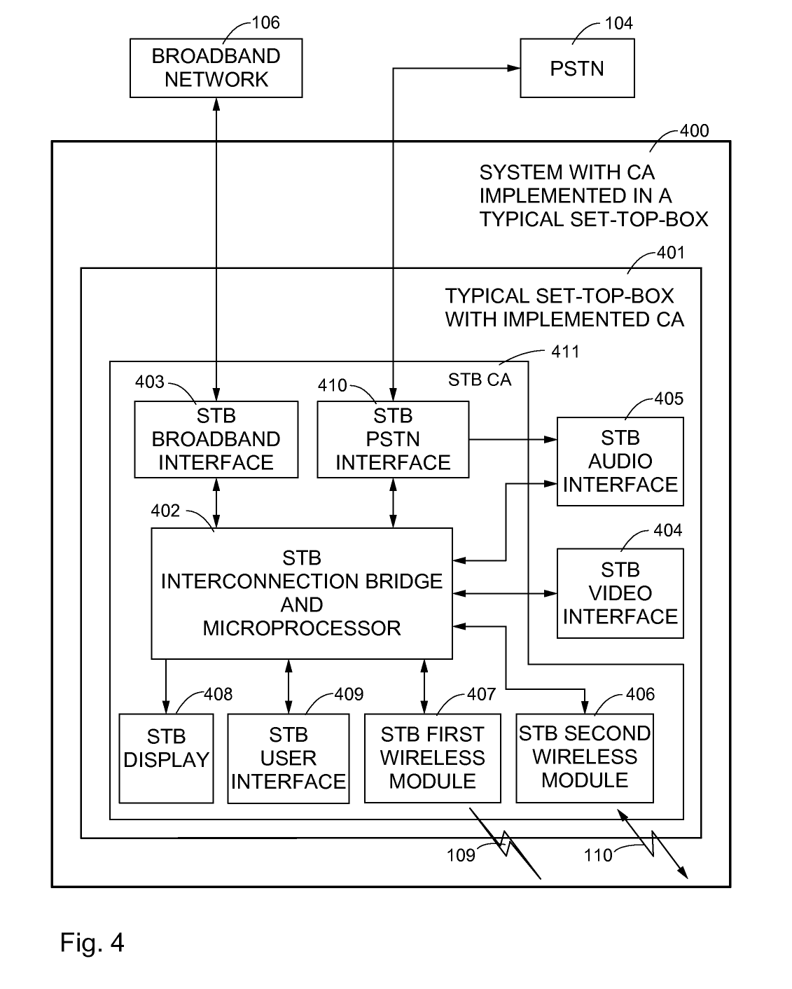

FIG. 4 is a general schematic block diagram of an embodiment of an example of communication system with call adapter implemented in a typical set-top-box 400 according to the present invention.

STB CA 411 is an implementation according to another embodiment of call adapter (102).

A STB (set-top-box) interconnection bridge and microprocessor 402 is the heart of the typical set-top-box with implemented call adapter 401. The STB (set-top-box) interconnection bridge and microprocessor 402 handles complex processing functions such as decoding, transcoding/encoding (converting from one format to another) and transrating (scaling from a higher to a lower bit rate) of various media streams. Besides broadcast content, the STB (set-top-box) interconnection bridge and microprocessor 402 can seamlessly support content from a home network or from the internet directly.

The STB interconnection bridge and microprocessor 402 performs the required interconnections between the internal blocks and coordinates the operations of the STB CA 411.

A STB broadband interface 403 allows interactive TV, gaming, streaming audio and video, voice over IP (VoIP) telephony to transmit and receive through broadband network 106 (such as ADSL and cable TV).

The video interface 404 provides the ability to interface to different video sources (such as TV, video camera) to be selected by the STB (set-top-box) interconnection bridge and microprocessor 402.

An STB audio interface 405 allows audio to be digitized by an audio codec and processed by the STB (set-top-box) interconnection bridge and microprocessor 402 to provide the audio requirements. The audio is also converted back to analog format and made available via the output jack and headphones (not illustrated here). The STB audio interface 405 can play tones such as dial tones, ring tones and busy tones during a call establishment by the STB CA 411.

A STB second wireless module 406 provides the ability to interface to a local area network (such as Wi-Fi, not illustrated here).

The STB CA 411 can use the STB first wireless module 407 to wirelessly transmit and receive data through the first wireless communication link 109 and can use the STB second wireless module 406 to wirelessly transmit and receive data through the second wireless communication link 110.

The STB display 408 provides the ability to display the status of the typical set-top-box with implemented call adapter 401 and the status of its activities.

A STB user interface 409 allows the user to control video/audio and input/output sources and communication with the LAN network (not illustrated here).

The STB PSTN interface 410 is used to provide the standard interface to the PSTN 104 and is implemented, but not limited to, by a standard DAA (data access arrangement).

In order to place a call from the cellular phone (wireless enabled) 107 through the typical set-top-box with implemented call adapter 401, the calling party selects the called party from the list of names stored in the cellular phone and transmits the associated data in a defined file format (such as vCard for electronic “business cards”) to the typical set-top-box with implemented call adapter 401 through the first wireless communication link 109. The typical set-top-box with implemented call adapter 401 extracts from the received data the called party required data to place the call and can start to establish the call to the PSTN 104 or to the broadband network 106, according to calling party selection. The typical set-top-box with implemented call adapter 401 can establish the call as a regular/traditional analog call or as a VoIP (voice over internet protocol) call, according to calling party selection. The typical set-top-box with implemented call adapter 401 can play the dial tones, the ring tones and the busy tones through its STB audio interface 405 and can forward the dial tones, the ring tones and the busy tones through the first wireless link 109 to the cellular phone (wireless enabled) 107 or to the first call forwarded wireless enabled device 103 (not illustrated here) , or through a second wireless link 110 to the second call forwarded wireless enabled device 108 (not illustrated here), according to the calling party selection. The typical set-top-box with implemented call adapter 401 can forward the call through the first wireless link 109 to the cellular phone (wireless enabled) 107 or to the first call forwarded wireless enabled device 103 (not illustrated here), or through the second wireless link 110 to the second call forwarded wireless enabled device 108 (not illustrated here), according to the calling party selection.

The typical set-top-box with implemented call adapter 401 can detect the voice communication end and release the call.

The components shown in blocks in the present illustration are operatively connected, as described with the arrows

While the invention has been described with respect to a limited number of embodiments, it will be appreciated that many variations, modifications and other applications of the invention may be made.

What is claimed is:

1. A communication system comprising:
(a) a call adapter, said call adapter including:
(i) a call adapter interconnection bridge and microprocessor.

2. The communication system of claim 1, wherein said call adapter further includes:
(ii) a call adapter telephone interface operatively connected to said call adapter interconnection bridge and microprocessor.

3. The communication system of claim 2, wherein said call adapter further includes:
(iii) a call adapter broadband interface operatively connected to said call adapter interconnection bridge and microprocessor.

4. The communication system of claim 3, wherein said call adapter further includes:
(iii) a call adapter public switched telephone network interface operatively connected to said call adapter interconnection bridge and microprocessor.

5. The communication system of claim 3, wherein said call adapter further includes:
(iv) at least one call adapter wireless module operatively connected to said call adapter interconnection bridge and microprocessor.

6. The communication system of claim 3, wherein said call adapter further includes:
(v) a call adapter display operatively connected to said call adapter interconnection bridge and microprocessor;
(vi) at least one call adapter user interface operatively connected to said call adapter interconnection bridge and microprocessor;
(vii) at least one call adapter liquid-emitted diode operatively connected to said call adapter interconnection bridge and microprocessor; and
(viii) a call adapter speaker operatively connected to said call adapter public switched telephone network interface.

7. The communication system of claim 1 further comprising:
(b) a cellular phone, wireless enabled, operatively connected to said call adapter; and
(c) a telephone operatively connected to said call adapter.

8. The communication system of claim 7 further comprising:
(d) at least one call forwarded wireless enabled device operatively connected to said call adapter.

9. The communication system of claim 6 further comprising:
(b) a cellular phone, wireless enabled, operatively connected to said call adapter; and
(c) a telephone operatively connected to said call adapter.

10. The communication system of claim 9 further comprising:
(d) at least one call forwarded wireless enabled device operatively connected to said call adapter.

11. The communication system of claim 1, wherein said call adapter is a, set-top-box, call adapter, and wherein said call adapter interconnection bridge and microprocessor is a set-top-box interconnection bridge and microprocessor.

12. The communication system of claim 11, wherein said set-top-box call adapter further includes:
(ii) at least one interface selected from a group consisting of a set-top-box broadband interface, a set-top-box public switched telephone network interface, a set-top-box wireless module, and a set-top-box user interface.

13. A method of placing, establishing, forwarding and releasing a call comprising the main stages of:
(a) starting a call adapter configuration and placing, establishing, forwarding and releasing a call;
(b) placing said call;
(c) establishing said call;
(d) forwarding said call;
(e) releasing said call; and
(f) ending said call adapter configuration and placing, establishing, forwarding and releasing a call.

14. The method of claim 13, wherein the main stage of starting the call adapter configuration and placing, establishing, forwarding and releasing a call includes the sub-stage of:
(i) transmitting said configuration data from a cellular phone, wireless enabled, to the said call adapter.

15. The method of claim 13, wherein the main stage of placing the call includes the sub-stages of:
(i) inserting called party data on a cellular phone, wireless enabled; and
(ii) transmitting the called party data from said cellular phone, wireless enabled, to a call adapter.

16. The method of claim 13, wherein the main stage of placing the call includes the sub-stages of:
(i) selecting an existent called party on a cellular phone, wireless enabled; and
(ii) transmitting said called party data from said cellular phone, wireless enabled, to a call adapter.

17. The method of claim 13, wherein the main stage of establishing the call includes the sub-stages of:
(i) receiving called party data by a call adapter;
(ii) extracting the required called party data for call placement by a call adapter and starting a standard establishing call procedure, according to the calling party selection; and
(iii) playing call progress tones by said call adapter and forwarding a call progress tones.

18. The method of claim 13, wherein the main stage of forwarding the call includes the sub-stages of:
(i) forwarding a call by a call adapter to a telephone handset.

19. The method of claim 13, wherein the main stage of forwarding the call includes the sub-stages of:
(i) forwarding a call to a calling party cellular phone, wireless enabled.

20. The method of claim 13, wherein the main stage of forwarding the call includes the sub-stages of:
(i) forwarding a call to a call forwarded wireless enabled device.

21. The method of claim 13, wherein the main stage of releasing the call includes the sub-stages of:
(i) releasing said call by a call adapter after a telephone handset is on-hook.

22. The method of claim 13, wherein the main stage of releasing the call includes the sub-stages of:
(i) releasing said call by a call adapter after a wireless enabled device's call is released.
